(19) United States
(12) Patent Application Publication
(10) Pub. No.: US 2021/0098807 A1
(43) Pub. Date: Apr. 1, 2021

(54) ORGANIC FRAMEWORKS TO BLOCK HYDROGEN AND OXYGEN GASES IN FUEL CELLS

(71) Applicant: MPOWER INNOVATION, INC., Menlo Park, CA (US)

(72) Inventors: Yongbong Han, San Francisco, CA (US); Michael Duchul Pak, Belmont, CA (US); Robert Mark McDowell, Sheridan, WY (US); Feras Hamed Rabie, Tomball, TX (US)

(21) Appl. No.: 17/034,525

(22) Filed: Sep. 28, 2020

Related U.S. Application Data
(60) Provisional application No. 62/907,237, filed on Sep. 27, 2019.

(51) Int. Cl. H01M 8/106; H01M 4/90; H01M 8/1062

(52) U.S. Cl. CPC H01M 8/106; H01M 8/1062; H01M 4/9008

(57) ABSTRACT

Covalent Organic Frameworks (COFs) or Metal Organic Frameworks (MOFs) are synthesized to transport proton ions in PEM fuel cell applications. The pore size of organic frameworks and the number of sulfonyl functional groups inside their pores are controlled to maximize the proton conductivity and minimize the H₂ and O₂ crossover thru the membrane. The surface of MOF or COF crystal flakes is chemically modified to improve the mixability with polymer binder and this avoids the formation of physical defects or voids between polymer binder and crystals. The proton conducing membrane is made by dissolving a polymer binder in a solvent and then adding the chemically modified flakes into the solution and forming it into a film. The MOF or COF flakes can also be coated onto the proton conducting polymer membranes or continuously grown into larger size of films in solutions.

### RELATED APPLICATION

This application claims priority from U.S. Provisional Application No. 62/907,237 filed on Sep. 27, 2019.

### FIELD OF THE DISCLOSURE

The disclosure herein relates to organic frameworks such as covalent organic frameworks (“COF”) and metal organic frameworks (“MOF”) used as proton conducting materials, proton conducting membranes and their use of proton conducting membranes in fuel cells. Moreover, the disclosure herein relates to a method for the synthesis of proton conducting organic frameworks, the production of proton conducting membrane, preferably of fuel cells.

### BACKGROUND

Fuel cells are considered environmentally friendly, because they have zero emission of CO2 and produce pure water as byproducts. The proton exchange membrane (PEM) fuel cells have been used for mobile applications, especially in electric cars. Nafion™ is a perfluorinated polymer functionalized with sulfonyl side groups and commonly used as a proton exchange membrane in fuel cells. Nafion™ and its derivatives have been commercially available since the middle 1960's.

Other proton conducting polymers have been examined for the use as membrane materials in fuel cells. Phosphonic-acid (Phosphoryl) side groups are incorporated into perfluorinated polymers, because the proton conductivity is attributed to the side groups. The synthesis and characterization of the polymers are described in the publication (M. Yamabe. K. Akiyama, Y. Akatsuka, M. Kato. Novel phosphonated perfluorocarbon polymers. Eur. Polym. J. 36 (2000)1035-41). The use of these types of polymers in fuel cells is described in U.S. Pat. No. 6,087,032. However, proton conducting polymers are almost exclusively sulfonated materials.

Pendant sulfonic acid groups are incorporated into modularly built crystalline porous frameworks for intrinsic proton conduction. Two sulfonated covalent organic frameworks (COFs) are prepared by a mechano-assisted synthesis. They possess one dimensional nano-porous channels decorated with pendent sulfonic acid groups. These COFs exhibit high intrinsic proton conductivity as high as 3.96×10'S/cm with long-term stability at ambient temperature and 97% relative humidity (RH). They were blended with nonconductive polyvinylidene fluoride (PVDF) affording a series of mixed-matrix membranes (MMM) with proton conductivity up to 1.58×10'S/cm and low activation energy of 0.21 eV suggesting the Grotthuss mechanism for proton conduction. Because of the high intrinsic proton conductivity of COFs, they are expected to have their wide applications in proton exchange membranes. (Yongwu Peng, Mechanoassisted Synthesis of Sulfonated Covalent Organic Frameworks with High Intrinsic Proton Conductivity, ACS Appl. Mater. Interfaces 2016, 8, 18505-18512)

A sulfonic acid functionalized metal-organic framework (S-IRMOF-3) has been synthesized by dropwise addition of chlorosulfonic acid (0.5 mL) in IRMOF-3 (1 g) containing 20 mL of CHCl₃ at 0° C. under simple stirring. The catalyst was applied in Knoevenagel condensation of various aromatic and heteroaromatic aldehydes forming acrylonitrile derivatives. The presence of characteristic bands in the XRD pattern and in the solid state 13C MAS NMR spectrum confirmed the successful formation of catalyst. This new eco-friendly approach resulted in a significant improvement in the synthetic efficiency (90-96% yield), high product purity, and minimizing the production of chemical wastes without using highly toxic reagents for the synthesis of acrylonitriles with selectivity for (Z)-isomer. The catalyst could be reused for five consecutive cycles without substantial loss in catalytic activity. (Ryhan Abdullah Rather and Zeba N. Siddiqui, Sulfonic acid functionalized metal-organic framework (S-IRMOF-3): a novel catalyst for sustainable approach towards the synthesis of acrylonitriles, RSC Adv., 2019, 9, 15749-15762)

PEM fuel cells have two electrodes which are separated from each other by a proton exchange membrane (PEM). Hydrogen gases are converted into proton ions at the anode catalyst and transported thru the PEM, and then react with 02 gases to produce water at the cathode catalyst. Proton ions are transported with the help of sulfonyl groups which are pendent to the perfluorocarbon polymers in the Nafion™ membrane. The membrane transports proton ions while it blocks H₂ and O₂ gases. (Amol Prataprao Nalawade, Modification and Evaluation of Fuel Cell Membranes, Ph.D. thesis, The University of Southern Mississippi, 2011)

Nafion™ is the polymer which has a linear fluorocarbon chain as a backbone and sulfonyl groups as side chains. The linear backbone can be densely aligned and crystallized while the side groups interrupt the crystallization and help form an amorphous phase. Side sulfonyl groups in the amorphous phase attract water molecules and form ion clusters. The number of sulfonyl groups is proportional to proton conductivity up to a certain level.

There are two types of water molecules in the ion clusters. The first type of water is tightly bonded to sulfonyl groups. The other type is a free water molecule which does not significantly interact with sulfonyl groups, because it is far enough away from the sulfonyl group's attraction. Free water molecules can improve the proton conductivity and, they also cause the convective flow or rapid increase of permeability of H₂/O₂ gases under the pressure of the gas flow. This can cause H₂ and O₂ crossover through the membrane during operation. ((1) Jing Shan, Local resolved investigation of hydrogen crossover in polymer electrolyte fuel cell, Energy, Volume 128, 1 Jun. 2017, Pages 357-365; (2) Zijie Lu, State of Water in Perfluorosulfonic Ionomer (Nafion™) Proton Exchange Membranes, Journal of The Electrochemical Society, 155 2 B163-B171 2008).

When hydrogen and oxygen gases permeate thru the membrane, both gases directly react with each other at one of the electrodes. The direct reaction of H₂ and O₂ gases causes the following problems:

1) The reaction is exothermic and can cause a hot spot at the boundary of membrane and electrodes. This creates pin holes and reduces the lifetime of the fuel cells.

2) It produces peroxide radicals which can decompose the membrane.

3) The equilibrium potential of direct reaction of H₂ and O₂ gases stays between the equilibrium potentials of anodic reaction (H₂→2H⁺+2e⁻) and cathodic reaction (2H⁺+½.O₂+2e⁻→H₂O). This causes the depression of fuel cell voltage by mixed potential of two reactions. ((1) Jing Shan, Local resolved investigation of hydrogen crossover in polymer electrolyte fuel cell, Energy, Volume 128, 1 Jun. 2017, Pages 357-365; (2) P. Trinke, Experimental evidence of increasing oxygen crossover with increasing current density during PEM water electrolysis, Electrochemistry Communications 82 (2017) 98-102).

As explained above, COFs and MOFs have confined pores which have sulfonyl groups inside. When these materials are used in proton exchange membranes, ion clusters are formed inside the confined pores. This may limit the number of free water molecules. The proton conductivity and the convective flow of water in PEM can be controlled by adjusting the number of free water molecules inside the pores. Controlling the pore size allows the COF or MOF to host only a critical amount of free water molecules which helps to reach highest proton conductivity of the membrane and also minimizes the convective flow of free water through the membrane.

MOF and COF flakes should be incorporated into the membrane without any physical voids or macropores between the flakes and polymer binder. The flakes can be incorporated into membranes by mixing them with polymer binders in conventional way. Another common way to make the membranes is to mix with a proton conducting polymer binder such as Nafion™ and flakes in a solvent and then coat onto a glass plate. In this case, the physical voids may become a significant factor causing an increase in fuel crossover. In order to solve this problem, the following methods are under development by Mpower Innovation.
1) The flakes can be mixed with polymer binder and then be coated on one side of Nafion™ membrane.
2) The surface of the flakes is chemically modified to easily mix with PIMs (polymers of intrinsic microporosity). PIMs can fill the voids among the flakes and bond them tightly.
3) MOF/COF can be grown into a large membrane during synthesis.
4) Since MOF/COF can have 3D structure, it is expected to control better the convective flow of free water.

### SUMMARY

Disclosed herein is a methodology for the synthesis of proton conducting MOFs or COFs. MOF and COF structures disclosed herein and the fabrication methodologies are ultimately directed to a proton conducting membrane made from a polymer binder and a proton conducting MOF or COF. The polymer binder can be comprised of proton conductive or nonconductive polymers.

This disclosure further details improving the property of the membrane which can minimize the fuel crossover but maximize its proton conductivity.

This disclosure further details method for production of a proton conducting membrane. The method details an approach to minimize the formation of physical defects or voids which may exist between MOF or COF flakes and the polymer binder.

### BRIEF DESCRIPTION OF THE DRAWINGS

FIG. 1 illustrates a covalent organic framework (COF) dispersion in polymer solution; and

FIG. 2 illustrates the resulting COF layer on a porous support after the filtration process.

### DETAILED DESCRIPTION

The membrane and fabrication methodologies disclosed herein detail a sulfonated COF/MOF which transports proton ions but blocks H₂ and O₂ gases from passing through proton exchange membrane for fuel cell or electrolysis (H₂ generation) applications. Sulfonyl groups are incorporated into the pores of COFs/MOFs.

The present invention provides a proton conducting membrane which utilizes a composite of polymer binder and COF/MOF. The proton conductivity of known proton conducting membranes can be increased through the admixture of MOFs/COFs. To produce the membrane disclosed herein, polymers of intrinsic micro-porosity (PIMs) are first dissolved in a polar and organic solvent. Fine-crystalline MOF/COF particles are then added to this solution. After casting, the composite membranes produced in this manner are dried.

The advantage of the fabrication methodology disclosed herein is that composite membranes using MOFs/COFs are designed to block H₂ and O₂ gases while they maintain excellent proton conductivity in PEM fuel cells. The proton conductivity of the membrane according to the invention is at least equal to or higher than conventional membranes, e.g. made of Nafion™.

Sulfonyl groups pendant to the pores of COFs/MOFs can attract water molecules and form ionic clusters. Proton ions are transported via ionic clusters at high relative humidity (95%). The maximum number of the sulfonyl groups can be incorporated into the organic frameworks. This can maximize the proton conductivity of composite membranes. On the other hand, when water molecules fill the pores of MOFs/COFs by interacting with the functional groups, any extra free water molecules can be limited by controlling the pore size, thereby blocking H₂ and O₂ gas transportation.

The COFs/MOFs are preferably available in crystalline form, in particular in crystal particles. The crystal particles preferably have an extension of approximately 0.1 um to 55 um and especially preferably of 0.4 um to 15 um. With a composite membrane, the extension is preferably in the range of 0.1 urn to 1.5 um, in particular 0.6 um.

The polymer binder in the composite membrane is preferably a covalently bonded, negatively charged functional group. It can be a polyelectrolyte layer, wherein its ionic groups are bonded to perfluorinated and/or hydrocarbon-based polymer frames or polymers. The polymer binder is used as a glue to hold MOFs/COFs together. Any kind of hydrophobic and non-proton conductive polymer can also be used as polymer binder.

The polymers, which can be used as binder in the membrane, should be compatible with proton-conducting, polymer electrolytes, include Nafion™ and/or, in particular sulfonated, phosphonated or doped, poly(amide imide), poly(ether Sulfone), poly(ether ether ketone), poly(ether ketone ketone), poly(ether imide), poly(phosphaZene), poly(phenoxyben Zoyl phenylene), poly(benzimidazole) and poly(azole).

For this, the polymer has acid-conductive groups, e.g. Sulfone carboxyl, phosphone, Sulfonimide or boric-acid groups. The polymers made of poly(amide imide), poly(ether sulfone), poly(ether ether ketone), poly(ether imide), poly(phosphaZene) and poly(phenoxybenzyl phenylene) thereby comprise Sulfone, carboxyl, phosphone or Sulfonimide groups. The polymer made of poly(benziamidaZole) or poly(azole) can comprise Sulfone, carboxyl, phosphone, Sulfonimide or boric acid groups.

A preferred COF/MOF is a sulfonated organic framework, which has the repetition units of the following structure:

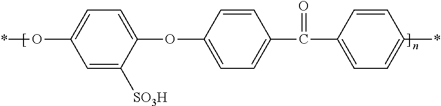

The preferred sulfonation level of COF/MOF is less than 70% and preferably less than 50%. Studies show that as the sulfonation level increases, the proton ionic conductivity increases and levels off at the certain degree of sulfonation while H₂ and O₂ crossover starts at a specified threshold of sulfonation. This indicates that the best performance should be found at the optimum pore size and degree of sulfonation.

Covalent organic frameworks (COFs) are mainly two-dimensional organic solids with extended structures in which building blocks are linked by strong covalent bonds. COFs are porous and crystalline and are made mainly from light elements (H, B, C, N, and O). Metal-organic frameworks (MOFs) are a class of compounds consisting of metal ions or clusters coordinated to organic ligands to form one-, two-, or three-dimensional structures. The size and the chemical environment of the created pores are defined by the length and the functionalities of the organic unit.

The physical properties of COFs/MOFs are determined by the pore size, chemical structure of the framework, and the functional groups pendant to the pores of the organic frameworks. The separation distance of the functional groups of the organic components mainly specifies the pore size; the type of metallic component(s) decides potential catalytic properties in MOFs. (S. Kitagawa, et al. Angew. Chem. Int. Ed. 43 (2004) 2334)

Various functional groups such as sulfonyl and phosphoric acidic group can easily be incorporated into the pores of COFs/MOFs. MOFs or COFs with pore sizes between 0.3 nm to 1.5 nm are preferred since MOFs or COFs with larger pores have centers which are available for organic modifications or functionalization, whereby the proton transport is promoted. Preferred bivalent transition metals in MOFs are Zn, Cu Co, Ni, Cd, Fe, Mo, Rh and Mn. However, trivalent Al (aluminum) and tetravalent or pentavalent V (vanadium) are also important.

The surface of organic frameworks can be chemically modified to improve the mixability with polymer binders or have chemical bonds with the binders by introducing secondary functional groups into their surface. This allows the fabrication of a membrane which is very tough and does not have physical defects or voids between the organic framework crystals and polymer binders.

COFs or MOFs can have heterogeneous growth of crystals on various substrates. Good examples of the different substrate are nonwoven fabric, e-teflon, glass-plate, and etc. (Korean paper, Korea Advanced Institute of Science and Technology). Organic frameworks can be continuously grown into liquid crystal layers and form a membrane in which crystals are connected with grain boundary. The disclosed membrane has a high proton conductivity at temperatures lower than 80° C.

The membrane serves as a barrier to gas/liquid diffusion; however, the protons are allowed to pass through. The migration of protons through the organic frameworks must be balanced through the flow of the electronic charge through the outer circuit, so that this balance creates electrical energy. The proton movement in the membrane is connected or coupled with the water content of the membrane. Too much water can cause the fuel gas and oxygen to crossover through the membrane.

Polymer membranes suffer from a permeability/selectivity trade off. Inorganic membranes are brittle and lack physical integrity. And mixed matrix membranes (MMMs) become physically unstable at filler loadings in the polymer (matrix) which possess good performance. State of the art COF membranes have been fabricated with some success using techniques that include “baking” the COF solution, interfacial polymerization, nucleation and growth, phase transfer polymerization, solvothermal approach, solid-vapor interface reaction, using a Langmuir-Blodgett trough, and mixed matrix membranes. Although, ultra-thin membranes have been achieved using some of these approaches, they lack simplicity and scalability.

The technology disclosed herein overcomes these challenges by incorporating the COF and the polymer matrix on a porous support by way of filtration. The primary difference between the presented membrane and an MMM is that the presented membrane final composition is primarily of filler or COF material. MMMs are primarily constructed from the polymer or matrix. Loadings of 50% or higher in MMMs are rare and usually result in membrane physical failure.

The presented technique facilitates loadings of 80% to 99%. This results in the incorporation of the polymer playing a minimal role in the transport of constituents. The polymer is used to fill any voids between the COF material to avoid uninhibited transport. In addition, the polymer is used to “glue” the COFs together and to glue the COF to the porous support. Finally, the majority of the membrane functionality is to transport or to inhibit the transport of gases or to block a virus while maintaining sufficient air flow.

There have been COF membranes that use filtration or vacuum assisted assembly as a mechanism of membrane fabrication. These methods fail to use a polymer or “glue” in the filtration solution which results in long term instability. One other study also used filtration as a method of membrane fabrication. To eliminate the interfacial voids between the COF material, a post fabrication process of hot pressing was used on the membrane. The concepts disclosed herein are the first of their kind to introduce a polymer in the COF dispersion to eliminate interfacial voids and enhance long term mechanical stability.

This disclosure details the novel fabrication technique of membranes that consist of covalent organic frameworks (COFs) and polymers and/or adhesives. The polymers and/or adhesives act as a filler between the COF flakes, layers, and/or particles. These fillers prevent uninhibited transport of gases (for applications pertaining to gas separation, air filtration, and personal protection equipment); liquids (for applications pertaining to desalination and virus filtration); solids (for applications pertaining to virus capture and/or killing, pollen capture, and dust capture). In addition, the polymers and/or adhesives act as a glue to keep the COF material stuck together and/or keep the COF material stuck to an organic or inorganic porous or non-porous support.

The novel membrane fabrication process disclosed herein is a filtration process of COF materials in a polymer/solvent solution. A dispersion of COF is attained in a polymer solution. The dispersion/solution is filtered through the porous support where most of the solubilized polymer and solvent pass through the porous support to the filtrate. What remains on the porous support are the COF flakes, layers, and/or particles which are surrounded by a microscopic and/or macroscopic layer of polymer solution. This solution surrounds each COF constituent independently and collectively, allowing for a microscopic and/or macroscopic polymer and/or adhesive film formation after solvent evaporation.

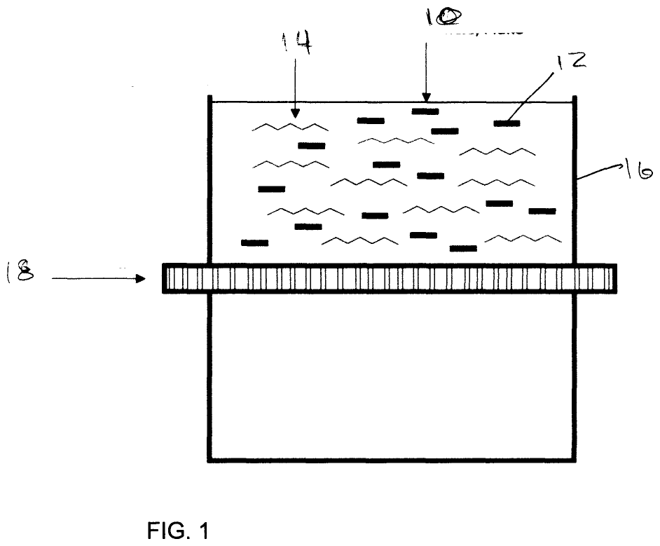

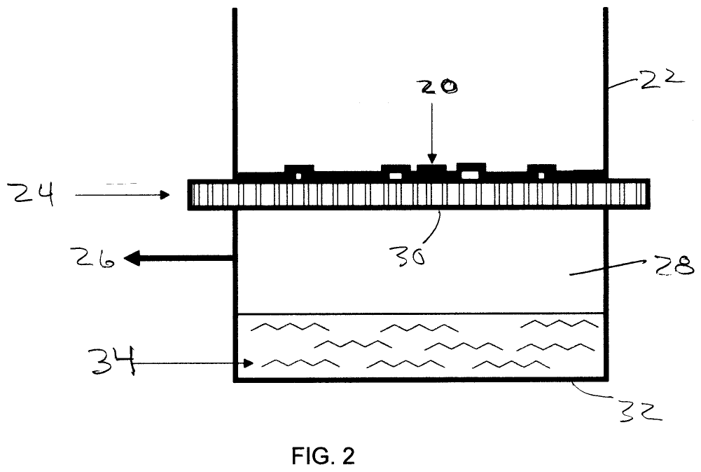

The filtration process disclosed herein is illustrated by way of example in the figures of the accompanying drawings in which like references indicate similar elements. FIG. 1 illustrates an exemplary COF dispersion in a polymer solution. Specifically, FIG. 1 reveals a dispersed covalent organic framework COF 10 comprised of particles and flakes 12 along with a dissolved polymer chain 14, all of which reside within a vessel 16. The COF 10 and particles/flakes are disposed atop a porous membrane support 18. FIG. 2 illustrates a COF layer on a porous support after the filtration process. Specifically, FIG. 2 illustrates a polymer coated covalent organic framework COF 20 that resides within, for example, a vessel 22 and is disposed above a porous membrane support 24 while a vacuum 26 is applied to a cavity 28 disposed beneath the lower surface 30 of the porous membrane support 24. At the bottom 32 of the vessel 22 are excess polymer chains 34. This environment is a COF dispersion in a polymer aqueous or non-aqueous solution. FIG. 2 illustrates the result of the filtration process after solvent evaporation which results in COF material surrounded by a microscopic and/or macroscopic polymer/adhesive film. In addition, additives such as plasticizers can be added to the solution to enhance gas transport through the deposited polymer films.

FIG. 1 embodies a COF dispersion in a polymer/adhesive solution ready to be filtered through and on a porous support. The polymer and class of polymer will vary depending on the application. Exemplary polymers are intrinsic micro porosity (PIMs), dense rubbery or dense glassy polymers (for transport to be used in air filtration devices and personal protection equipment such as face masks), ionic/charged polymers (for virus killing and/or trapping), proton conductive polymers (for hydrogen fuel cell applications) and in general any and all polymers used to “glue” the COF together and/or fill the voids between the COF layers, flakes, and/or particles.

The final COF membrane thickness is not limited to 19.5 um as that thickness can be attained with a higher dispersion concentration and/or a larger amount of dispersion volume being filtered through the membrane. In addition, a membrane thinner than 1.93 um can be attained through a less concentrated dispersion and/or a smaller dispersion volume being filtered through the membrane.

The membrane fabrication process disclosed herein uses a filtration or vacuum assisted method to produce a COF membrane. However, an alternative to an applied vacuum on the filtrate side of the membrane is a higher pressure can be used to filter the dispersion/solution on/through on the solution side of the membrane. The process so disclosed requires the use of a pressure gradient to filter the dispersion/solution on/through the membrane. The fabrication process utilizes a COF, polymer/additive, solvent solution to attain a membrane constructed primarily of COF material.

The COF material may have linkage types (prior to functionalization) such as, but not limited to, boroxines, boronic esters, imines, hydrazones, azines, ketoenamines, borosilicate, triazine, borazine, squararine, benzimidazole, benzobisoxazole, amine, azodioxy spiroborate, phenazine, and olefin. Post functionalization can change these linkages and are within the scope of the invention. The COF membrane being utilized will be in a staggered configuration. In addition, the solvent can be aqueous or organic or a combination of both and the support can range in porosity and be either organic or inorganic. The polymer/additive can be solubilized or melted.

The polymer/additive filtered through the porous support and utilized for the fabrication of a PEM membrane can be any polymer which includes but is not limited to glassy, rubbery, natural, synthetic, semi-synthetic, linear, comb-like or branched, polymer of intrinsic porosity, dense polymer, ionic/charged polymer and be combined with an additive.

The polymers/additive act as a filler between the COF flakes, layers, and/or particles to eliminate interfacial voids. The fabricated membrane can allow air flow while inhibiting solid particles such as viruses and particulates. The fabricated membrane can also allow water to pass through while rejecting ions for desalination processes. The fabricated membrane can allow protons to pass through while block hydrogen and oxygen from crossing over.

The COF being utilized for the fabrication of a virus and particulate filter is preferably in a staggered configuration to allow air flow across the membrane while blocking viruses and particulates; likewise, the staggered configuration allows water to pass through while blocking larger ions. The COF being utilized for the fabrication of the proton exchange membranes is in staggered formation and/or the pore walls functionalized to block fuel cross-over.

The COF pores may be functionalized to tailor the pore diameter for size exclusion transport. In addition, the use of a plasticizer may or may not be used to enhance permeability through the membrane and adhesion properties between the COF flakes. The use of a polymer/adhesive/additive to eliminate the interfacial voids between the COF flakes and/or be used as a “glue” to maintain membrane physical integrity is also contemplated by this disclosure.

A porous organic or inorganic support can be used to maintain COF/polymer physical integrity while the support does not need to be part of the final product rather only used for the membrane fabrication process.

In the current invention, this can be controlled by the chemical structures of the organic frameworks and polymer binder.

The invention will be described in greater detail through the following examples. The examples are intended to clarify the invention without restricting the application area in any way.

We claim:

1. The two-dimensional, porous, crystalline, stable covalent organic framework of formula-1

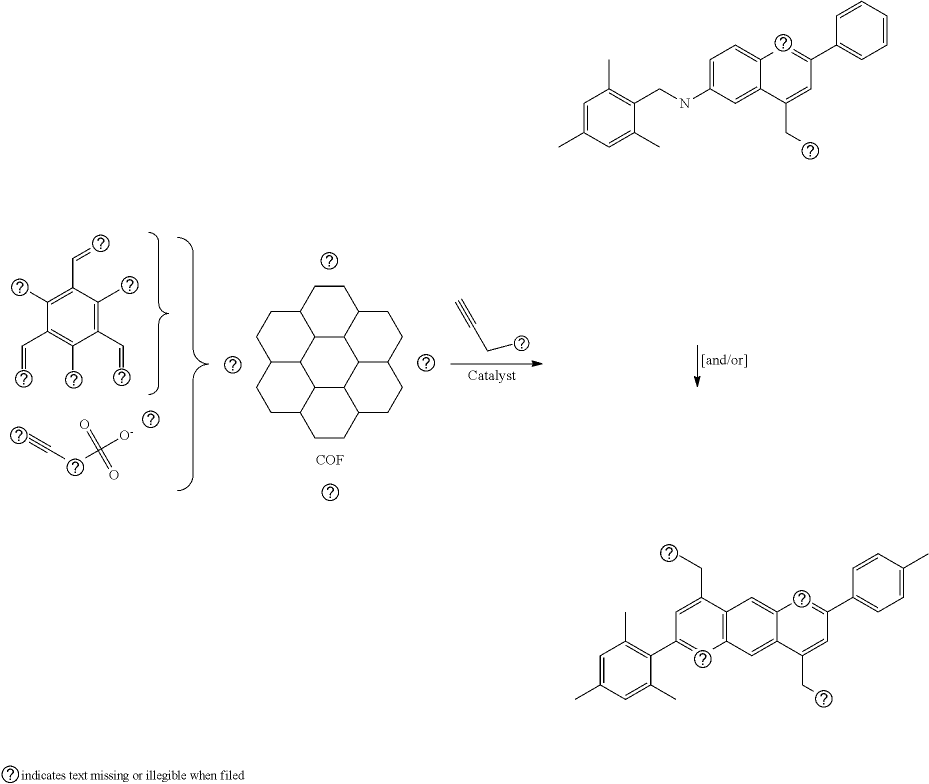

2. The covalent organic framework of claim 1, wherein the weight percentage of sulfonation is in the range of about 10-15%.

3. The covalent organic framework of claim 1, wherein each ring of the covalent organic framework comprises approximately one sulfonate ring.

4. The covalent organic framework of claim 1, wherein sulfonation of rings is in the range of 30-50%.

5. The covalent organic framework of claim 1, wherein the density of the covalent organic framework is about 0.20 g/cm³.

6. The covalent organic framework of claim 1, wherein a fluorine functional group is added.

7. The covalent organic framework of claim 6, wherein the fluorine functional group produces both hydrophobic and hydrophilic characteristics.

8. The covalent organic framework of claim 1, wherein a sulfonated quinoline is formed from an imine for stability.

9. The covalent organic framework of claim 1, wherein the framework has linkage types (prior to functionalization) selected from the group consisting of boroxines, boronic esters, imines, hydrazones, azines, ketoenamines, borosilicate, triazine, borazine, squararine, benzimidazole, benzobisoxazole, amine, azodioxy spiroborate, phenazine, and olefin.

10. A membrane electrode assembly for a fuel cell comprising:
an anode;
a cathode; and
a covalent organic framework proton exchange membrane with a thickness in the range of about 5 μm and an ion conductivity of approximately 0.1 S/cm.

11. The membrane electrode assembly of claim 10, wherein at least two proton exchange membranes are disposed adjacent one another.

12. The membrane electrode assembly of claim 10, wherein the proton exchange membrane has a conductance in the range of about 160-200 S/cm².

13. The membrane electrode assembly of claim 10, wherein the proton exchange membrane has a hydrogen permeation in the range of about 3-4 barrer.

14. The membrane electrode assembly of claim 10 wherein a polymer used as a binder in the proton exchange membrane is selected from the group consisting of Nafion™ sulfonated, phosphonated or doped, poly(amide imide), poly(ether Sulfone), poly(ether ether ketone), poly(ether ketone ketone), poly(ether imide), poly(phosphaZene), poly(phenoxyben Zoyl phenylene), poly(benzimidazole) and poly(azole).

15. The two-dimensional, porous, crystalline, stable covalent organic framework of formula-2

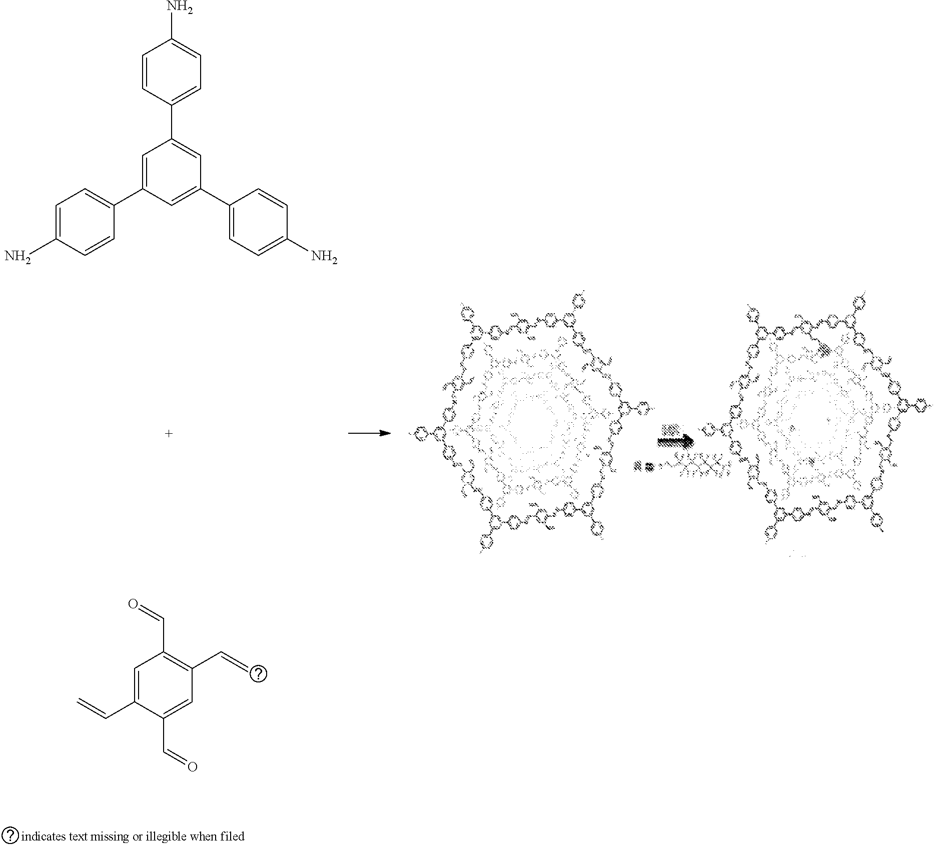 [SMILES: Nc1ccc(-c2cc(-c3ccc(N)cc3)cc(-c3ccc(N)cc3)c2)cc1 ; C=Cc1cc(C=O)c(C=C)cc1C=O]

16. A COF membrane fabrication process, the method comprising: application of a reduced atmospheric pressure on a filtrate side of the membrane to filter a solution through a solution side of the membrane wherein the fabrication process utilizes a COF, polymer/additive, solvent solution to attain a membrane constructed primarily of COF material.

17. A proton conducting membrane with pores, the membrane comprising: a polymer binder and at least one of (1) a metal organic framework (MOF), and (2) covalent organic framework (COF).

18. The proton conducting membrane according to claim 17, wherein the COF has covalently bonded, negatively charged functional groups such as sulfonated acid or phosphonated acid groups disposed internal to the pores.

19. The proton conducting membrane according to claim 17, wherein the polymer binder comprises one or more of a perfluorinated polymer with sulfonated and phosphonated acid groups as a side group.

20. The proton conducting membrane according to claim 17, wherein the polymer binder comprises one or more of a perfluorinated polymer without sulfonated and phosphonated acid groups as a side group.

21. The proton conducting membrane according to claim 17, wherein the polymer binder comprises one or more of a hydrophobic polymer with sulfonated and phosphonated acid groups as side group.

22. The proton conducting membrane according to claim 17, wherein the polymer binder comprises one or more of a hydrophobic polymer without sulfonated and phosphonated acid groups as side group.

23. The proton conducting membrane according to claim 17, wherein the MOFs/COFs have 3 functional groups in each pore.

24. The proton conducting membrane according to claim 17, wherein the MOFs/COFs have 6 functional groups in each pore.

25. The proton conducting membrane according to claim 17, wherein MOFs/COFs have a pore size in the range of about 0.3 to about 50 nm.

26. The proton conducting membrane according to claim 17, wherein MOFs/COFs comprise an organic linker that includes at least one of phosphonate, a carboxylate group, and a nitrogen donor complex.

27. The proton conducting membrane according to claim 17, wherein COF/MOF is porous and has coordination spots and water molecules on the inside of the pore walls.

28. The proton conducting membrane according to claim 17, wherein the surface of MOFs/COFs are chemically modified with hydrophobic chemical structures to prevent the permeation of water through a polymer binder phase.

29. The proton conducting membrane according to claim 17, wherein MOFs/COFs comprise in the range of 30-80% of the composite membrane.

30. The proton conducting membrane according to claim 17, wherein the membrane is operable in proton exchange membrane fuel cells or electrolytic hydrogen generators.
